(19) United States
(12) Patent Application Publication
(10) Pub. No.: US 2007/0134049 A1
(43) Pub. Date: Jun. 14, 2007

(54) Musical liquid dispensing apparatus

(76) Inventor: Terri Petrillo, Canoga Park, CA (US)

Correspondence Address: TOPE-MCKAY & ASSOCIATES, 23852 PACIFIC COAST HIGHWAY #311, MALIBU, CA, 90265, US

(21) Appl. No.: 11/586,336

(22) Filed: Oct. 24, 2006

Related U.S. Application Data
(60) Provisional application No. 60/730,083, filed on Oct. 24, 2005.

(51) Int. Cl. B43K 29/00; B43K 8/06

(52) U.S. Cl. 401/195; 401/198

(57) ABSTRACT

A musical liquid dispensing apparatus, suitable for drawing or writing while creating sounds, is presented. The musical liquid dispensing apparatus comprises a tubular casing having at one of its ends a mouthpiece and an elongate cap, and at its other end a nozzle having an orifice in communication with an expansion chamber. A liquid source including an elongate body and an absorbent nib is located within the casing with side surfaces of the pen body spaced from internal wall surfaces of the casing to define an air flow passageway therebetween. First and second stop means are provided within the casing to position the nib of the liquid source such that the liquid source can selectively be positioned with its nib within or in close proximity to the casing nozzle or with its nib effectively sealed within the elongate cap when the apparatus is not in use. The mouthpiece is configured with a sound-generating device to create a sound when a user blows into the mouthpiece to dispense a fine spray of liquid particles.

### PRIORITY CLAIM

The present application claims the benefit of priority of U.S. Provisional Patent Application No. 60/730,083, filed Oct. 24, 2005 entitled “Writing Instruments.”

### BACKGROUND

(1) Technical Field

The present invention relates to the field of writing instruments and liquid dispensing devices, and more specifically to an air brush with a sound-generating device configured to associate specific colors with specific sounds.

(2) Discussion

Air brushes and writing instruments have long been known in the art. Conventional air brushes comprise a liquid store connected to receive high pressure gas from a source. The high pressure gas passes over the liquid store to produce a spray of liquid particles which is directed by a nozzle onto an appropriate surface. The pressurized gas from the source is supplied to the air brush via a conduit and its flow is controlled by a manually operated or automatically controlled valve. Typically the pressurized gas source includes propellant and is contained in a heavy metal cylinder. JP-A-61042350 and UK 2177620A disclose such an air brush in which the liquid store takes the form of a felt-tipped pen.

British Patent 2245196 and International Patent Application PCT/GB93/02332 disclose an air brush apparatus for dispensing fine sprays of liquid particles. These air brushes comprise a hand or foot operated pump connected to supply air under pressure directly to a nozzle so positioned that air leaving the nozzle is directed onto and over a nib of a felt-tipped pen releasably supported within a holder with the absorbent nib of the pen in close proximity to the nozzle outlet to cause liquid from the nib to be dispensed as a fine particulate spray in air.

An airbrush including a cylindrical housing formed with a mouthpiece for use with a felt-tipped pen is disclosed in published British Patent Application 2257058. The pen disclosed in this application is of special design and includes an end cap formed with a hole to equalize the pressure within the pen reservoir to avoid the presence of a vacuum.

An improved tubular construction of air brush dispenser is disclosed in International Patent Application PCT/GB94/00959, which corresponds to international publication number WO 94/26,421 and to U.S. Pat. No. 5,687,886 (hereinafter “the '886 patent”). This dispenser comprises a hollow tubular housing and a felt-tipped pen which is retained within and spaced from the inner wall of the housing. The tubular housing includes at one end a nozzle and at its other end a mouth piece through which air can be caused to flow through the tubular housing and over the pen to the outlet orifice of the nozzle. An abutment is provided within the housing for locating the pen within the housing with its absorbent nib at least partially within the boundary of the outlet orifice of the nozzle.

PCT/EP96/01225, which corresponds to international publication number WO 97/03,757 and to U.S. Pat. No. 6,024,300 (hereinafter “the '300 patent”), sets out to provide a simplified and relatively inexpensive dispenser which, similar to earlier Application PCT/GB94/00959, removes the need for a pump but which, by a blowing action, causes the required fine spray of colored particles to be removed from a liquid store such as an absorbent nib of a pen containing a colorant, ink, paint or the like. The air brush dispenser of the '300 patent is an improvement over the earlier design of the '886 patent in that it provides a simple and very secure means for locating a pen or cartridge within the tubular casing and has an outlet nozzle with a profile that optimizes the flow of air around the nib of the pen or other liquid source thereby enabling even young children to operate the dispenser to achieve coloring effects normally associated with much more expensive and complicated equipment.

In the design disclosed in the dispensing apparatus described in PCT/EP96/01225, it is intended that when the dispensing apparatus is not in use, it can be rearranged so that the pen or cartridge is removed from its outer casing, inverted and re-inserted into the casing with the nib of the pen or cartridge covered by the cap. The intention of so doing is to seal the nib effectively within the cap to prevent it from drying out. However, it has been found that on many occasions this intention is not met. In transit for example, the pen has been found to move relative to the casing thereby at least partially exposing the nib to the air. Also, there have been occasions when the pen has been positioned too low within the casing after use, thereby not fully sealing the nib within the cap. Furthermore, it has been found that any slight movement or vibration of the apparatus can result in the pen or cartridge falling rearwardly into the casing, therefore withdrawing the nib from the cap with the same adverse results.

These problems causing the nib of the pen or the cartridge to be dried or damaged have been solved in the plurality of liquid dispensing apparatuses discussed by Bolton in “Liquid Dispensing Apparatus,” U.S. Pat. No. 6,283,388; in “Liquid Dispensing Apparatus,” U.S. Pat. No. 6,270,021; in “Liquid Dispensing Apparatus,” U.S. Pat. No. 6,024,300; and in “Hand-Held Liquid Dispensing Apparatus,” U.S. Pat. No. 5,687,886. In the “Liquid Dispensing Apparatus,” U.S. Pat. No. 6,283,388; Bolton discloses a liquid dispensing apparatus that when the apparatus is not in use, the liquid dispensing apparatus can be rearranged so that the nib of the pen or cartridge is fixed into position so that it is always sufficiently covered to prevent drying or other damage occurring.

Additional improvements to writing instruments for entertainment or learning purposes have also been made. Musical pens described in the art are capable of being used as both a writing device and as a wind instrument such a flute or a tuning instrument, such as those discussed by Hong K. Joo in “Musical Pen,” U.S. Pat. No. 4,371,278, by Fang-Yue Huang et al. in “Motion Lighting Pen with Light Variably Accompanying Sound Actuation,” U.S. Pat. No. 6,604,880, and by Ming-Jer Yang in “Tuning Pen,” U.S. Pat. No. 4,984,494.

In the “Musical Pen,” U.S. Pat. No. 4,371,278, a musical pen is disclosed that contains finger holes along the barrel of the pen, therefore allowing this musical pen to be used as a writing device and as a wind instrument such a flute. However, this musical pen dispenses ink without the user having to blow into the mouthpiece of the pen to provide the ink (regular bold point pen).

In the musical pen apparatus disclosed in “Motion Lighting Pen with Light Variably Accompanying Sound Actuation,” U.S. Pat. No. 6,604,880, the musical pen is motion activated, and as soon as the musical pen detects the user writing with the pen the musical pen continuously plays a musical tune stored in the pen. This musical pen stops playing music when the user stops writing with the pen.

Another relevant reference is the tuning pen apparatus in “Tuning Pen,” U.S. Pat. No. 4,984,494, which serves as a writing pen and as a tuning device by checking notes of the scale corresponding to a specific key signature.

All of the aforementioned references fail to disclose an air brush which incorporates the improved features of air brushes with a corresponding sound-generating or musical feature. Therefore, what is needed in the art is an air brush which combines a sound-generating feature for associative learning and entertainment.

The following references are presented for further background information:
[1] Hong K. Joo, “Musical Pen,” U.S. Pat. No. 4,371,278.
[2] Fang-Yue Huang et al., “Motion Lighting Pen with Light Variably Accompanying Sound Actuation,” U.S. Pat. No. 6,604,880.
[3] Ming-Jer Yang, “Tuning Pen,” U.S. Pat. No. 4,984,494.
[4] Bolton, “Liquid Dispensing Apparatus,” U.S. Pat. No. 6,283,388.
[5] Bolton, “Liquid Dispensing Apparatus,” U.S. Pat. No. 6,270,021.
[6] Bolton, “Liquid Dispensing Apparatus,” U.S. Pat. No. 6,024,300.
[7] Bolton, “Hand-Held Liquid Dispensing Apparatus,” U.S. Pat. No. 5,687,886.

### SUMMARY

The present invention provides a musical liquid dispensing apparatus, suitable for drawing and writing while creating sounds. The musical liquid dispensing apparatus comprises a tubular casing having at one of its ends a nozzle having an orifice in communication with an expansion chamber bounded by sides which diverge away from the orifice, and at the other of its ends a mouthpiece and an elongate cap, wherein the mouthpiece is configured to create a sound when a user blows air into the mouthpiece. The musical liquid dispensing apparatus further comprises a liquid source, which includes an elongate body and an absorbent nib within the tubular casing, with the side surfaces of the elongate body spaced from internal wall surfaces of the tubular casing to define an air flow passageway therebetween. The mouthpiece is configured with a sound-generating device to create a sound when a user blows into the mouthpiece to dispense a fine spray of liquid particles.

In a further embodiment of the present invention, the mouthpiece comprises an aperture and a means for creating sound through vibration, wherein the means for creating sound is movably attached to the aperture. Thereby allowing a user to create a sound by blowing air into the mouthpiece and passing varying levels of air through said aperture and through said means for creating sound, wherein the means for creating sound vibrates generating sounds.

In another embodiment, the aperture of the mouthpiece has a length and a width, and the sound being generated by the mouthpiece has a pitch which is linked to the length of the aperture. Therefore, the length of the aperture determines the pitch of the sound generated by the mouthpiece, wherein different aperture lengths create different sounds, or different pitch tones.

Another embodiment of the present invention comprises a first stop means within the casing against which a surface of the elongate body can abut to position the nib of the liquid source within or in close proximity to the nozzle orifice. In addition, this embodiment further comprises a second stop means within the casing against which a rearward end of the elongate body can abut to position the nib of the liquid source in a relatively airtight manner into one end of the elongate cap. In this embodiment, the other end of the elongate cap is closed, so that the liquid source can selectively be positioned with its nib within or in close proximity to the casing nozzle, or with its nib effectively sealed within the elongate cap when the apparatus is not in use. In this embodiment of the invention, when the apparatus is not in use, the liquid dispensing apparatus can be rearranged so that the nib of the pen or cartridge is fixed into position so that it is always sufficiently covered to prevent drying or other damage occurring.

In a further embodiment, the first and second stop means may be the same.

In yet another embodiment, the locating means may comprise a plurality of fins extending inwardly from inner surfaces of the casing. One or each stop means may comprise steps formed in these fins.

In a still further embodiment, the casing may be formed in two separable tubular parts, one such part terminating at one end in a socket into which one end of the other casing part can extend to define a relatively tight fit therewith. The liquid source may selectively be positioned with its nib within or in close proximity to the casing nozzle when in use. The first stop means within the casing allows the liquid source to extend into or be in close proximity to the orifice of the casing.

Alternatively, when the pen is not in use, the liquid source may be removed from the casing, inverted and re-inserted until the rearward end of the liquid source abuts against the second stop means within the casing. Thus, the liquid source is stably positioned with its nib effectively sealed within the elongate cap.

Furthermore, the liquid source may comprise a pen formed with a nib of absorbent material; such a liquid source is hereinafter referred to as a felt-tipped pen.

In the embodiment of the present invention, when the liquid source is positioned with its nib within or in close proximity to the casing nozzle, blowing through the mouthpiece causes air to flow into and through the expansion chamber to cause liquid particles to be removed from the surface of the absorbent nib of the pen and to produce a dispersion of these particles in air. Furthermore, the casing interior may be formed over at least a major part of its length with three or more generally flat sides, the apices between neighboring sides defining passageways for the flow of air when a pen or cartridge is positioned in the casing. In another construction, the casing interior is oval in cross-section.

In an alternative construction of another embodiment of the present invention, the locating means comprises an inner tube in which the liquid source locates, the air flow passageway being defined between the outer periphery of this tube and the internal periphery of an outer tube spaced from the inner tube and substantially coaxial there-with. Furthermore, the casing is preferably produced from a plastics material. However, other materials may be used to make the casing of the musical liquid dispensing apparatus.

Finally, as can be appreciated by one skilled in the art, the present invention also comprises a method for forming a musical liquid dispensing apparatus, suitable for drawing and writing while creating sounds, the method comprising an act of forming a tubular casing having at one of its ends a nozzle having an orifice in communication with an expansion chamber bounded by sides which diverge away from the orifice, and at the other of its ends a mouthpiece and an elongate cap, wherein the mouthpiece is configured to create a sound when a user blows air into the mouthpiece. The method further comprises an act of locating a liquid source including an elongate body and an absorbent nib within the tubular casing with side surfaces of the elongate body spaced from internal wall surfaces of the tubular casing to define an air flow passageway therebetween, whereby a user dispenses a fine spray of liquid particles to the orifice while creating a sound by blowing air through the mouthpiece and the passageway and passing a mixture of air and liquid over the nib and out though the orifice

The features of the above embodiments may be combined in many ways to produce a great variety of specific embodiments, as will be appreciated by those skilled in the art.

### BRIEF DESCRIPTION OF THE DRAWINGS

The objects, features, aspects, and advantages of the present invention will become better understood from the following detailed descriptions of the invention in conjunction with reference to the following appended claims, and accompanying drawings where:

FIG. 1 is an illustration of the functionality of a musical liquid dispensing apparatus according to one embodiment of the present invention;

FIG. 2a is an exploded side view illustration of the musical liquid dispensing apparatus according to one embodiment of the present invention;

FIG. 2b is a transparent side view illustration of an assembled embodiment of the musical liquid dispensing apparatus in a non-operational mode;

FIG. 3a is a side view illustration of an assembled embodiment of the musical liquid dispensing apparatus in the non-operational mode;

FIG. 3b is an exploded side view illustration of the musical liquid dispensing apparatus arranged in an operational mode;

FIG. 3c is a side view illustration of an assembled embodiment of the musical liquid dispensing apparatus in the operational mode; and

FIG. 4 is a detailed illustration of a sound-generating device of one embodiment of the present invention.

### DETAILED DESCRIPTION

The present invention relates to the fields of dispensing a fine spray of liquid particles, liquid dispensing apparatus known as air brushes, writing instruments, music instruments, wind instruments, music accessories, and interactive toys. More specifically, the present invention pertains to a musical liquid dispensing apparatus, suitable for drawing or writing while creating sounds. The following description, taken in conjunction with the referenced drawings, is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein. Furthermore it should be noted that, unless explicitly stated otherwise, the figures included herein are illustrated diagrammatically and without any specific scale, as they are provided as qualitative illustrations of the concept of the present invention.

Next, a brief introduction is provided in the form of a narrative description of the present invention to give a conceptual understanding prior to developing the specific details. Finally, a detailed description of the elements is provided in order to enable the reader to make and use the various embodiments of the invention without involving extensive experimentation.

### (1) Overview

In the following detailed description, numerous details are set forth in order to provide a more thorough understanding of the present invention. However, it will be apparent to one skilled in the art that the present invention may be practiced without being limited to these specific details. In other instances, well-known structures and devices are shown in block diagram form, rather than in detail, in order to avoid obscuring the present invention.

In addition, it is to be understood that the labels left, right, front, back, top, bottom, forward, reverse, clockwise and counter clockwise have been used in this disclosure for convenience purposes only and are not intended to imply any particular fixed direction. Instead, they are used to reflect relative locations and/or directions between various portions of an object.

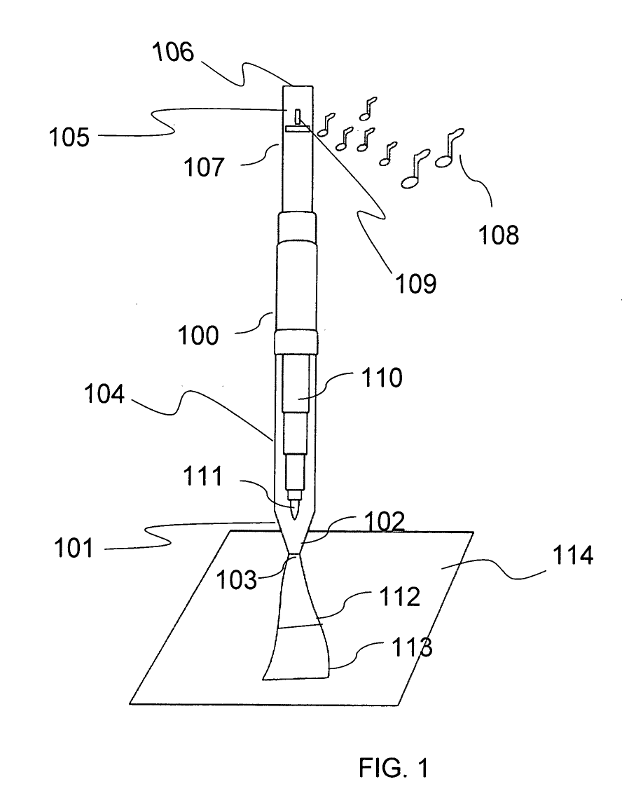

The present invention, in one embodiment, provides a musical liquid dispensing apparatus, suitable for drawing and writing while creating sounds. An image depicting the overall functionality of a musical liquid dispensing apparatus in an operating mode is shown in FIG. 1. In this embodiment, a tubular casing 100 has a first end 101 with a nozzle 102 having an orifice 103 in communication with an expansion chamber 104 bounded by sides which diverge away from the orifice, and a second end 105 with a mouthpiece 106 and an elongate cap 107, wherein the mouthpiece 106 is configured to create a sound 108 when a user blows air into the mouthpiece 106 and the air passes through a sound-generating device 109. In this embodiment, the sound-generating device 109 is a whistle mechanism that creates a whistling sound as air passes over an opening in the elongate cap 107. In addition, this embodiment of the invention further comprises a liquid source 110 in an elongate body and fluidly connected with an absorbent nib 111 within the tubular casing 100 with side surfaces of the elongate body spaced from internal wall surfaces of the tubular casing 100 to define an air flow passageway therebetween. Therefore, this embodiment of the invention allows a user to dispense a fine spray of liquid particles 112 through the orifice 103 while creating a sound 108 by blowing air through the mouthpiece 106 and the passageway and passing a mixture of air and liquid over the nib 111 and out though the orifice 103. This allows the user to paint, draw, or write with paint 113 on a surface 114 while playing musical sounds.

### (2) Example Embodiments of the Present Invention

The present invention has two principal aspects. The first is a musical liquid dispensing apparatus, suitable for drawing and writing while creating sounds.

The second aspect is a method for forming the musical liquid dispensing apparatus described herein, typically in the form of series of acts for: forming a tubular casing having at one of its ends a nozzle having an orifice in communication with an expansion chamber bounded by sides which diverge away from the orifice, and at the other of its ends a mouthpiece and an elongate cap, wherein the mouthpiece is configured to create a sound when a user blows air into the mouthpiece; and locating a liquid source including an elongate body and an absorbent nib within the tubular casing with side surfaces of the elongate body spaced from internal wall surfaces of the tubular casing to define an air flow passageway therebetween, whereby a user dispenses a fine spray of liquid particles to the orifice while creating a sound by blowing air through the mouthpiece and the passageway and passing a mixture of air and liquid over the nib and out though the orifice.

### (3) Description of Specific Elements

The general aspects of a musical liquid dispensing apparatus were described above in relation to FIG. 1. Specifics regarding an embodiment will now be presented. In particular, detailed discussions are provided regarding the main components of an embodiment of a musical liquid dispensing apparatus, suitable for drawing and writing while creating sounds.

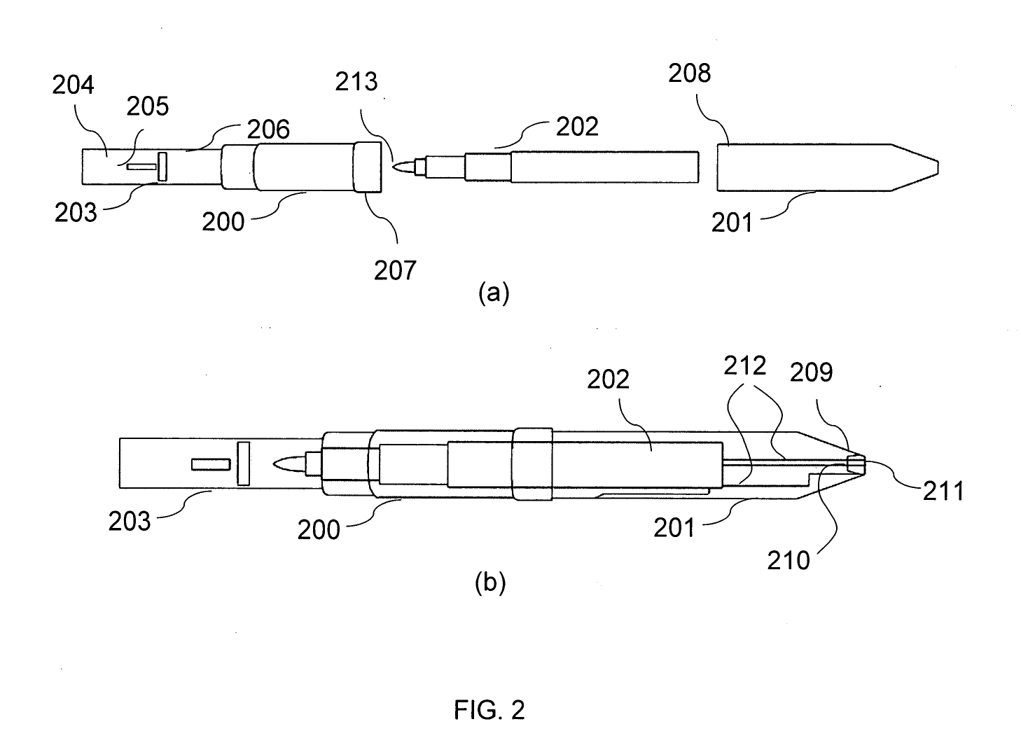

An exploded view illustration of the musical liquid dispensing apparatus in a non-operating mode is depicted in FIG. 2a, while FIG. 2b illustrates a semi-transparent view of the musical liquid dispensing apparatus in a non-operating mode. More specifically, FIG. 2a and FIG. 2b show various components of an embodiment of a musical liquid dispensing apparatus. As seen in FIG. 2, the apparatus comprises a tubular casing formed into a first section 200 and a second section 201, within which is housed a felt-tipped pen 202. The first section 200 has a mouthpiece 203 which comprises an annular passageway 204 about a tubular cap 205 disposed at one end. The cap 205 is spaced from the opposed internal wall surface of the first section 200 by three fins 206. At its end remote from the mouthpiece 203, the first section 200 is flared to define a socket 207 into which can fit in a relatively tight manner one end 208 of the second section 201. The second section 201 has a nozzle 209, shown in FIG. 2b, including an orifice 210 which opens into a converging expansion chamber 211. Three fins 212 protrude inwardly from the internal surfaces of the second section 201.

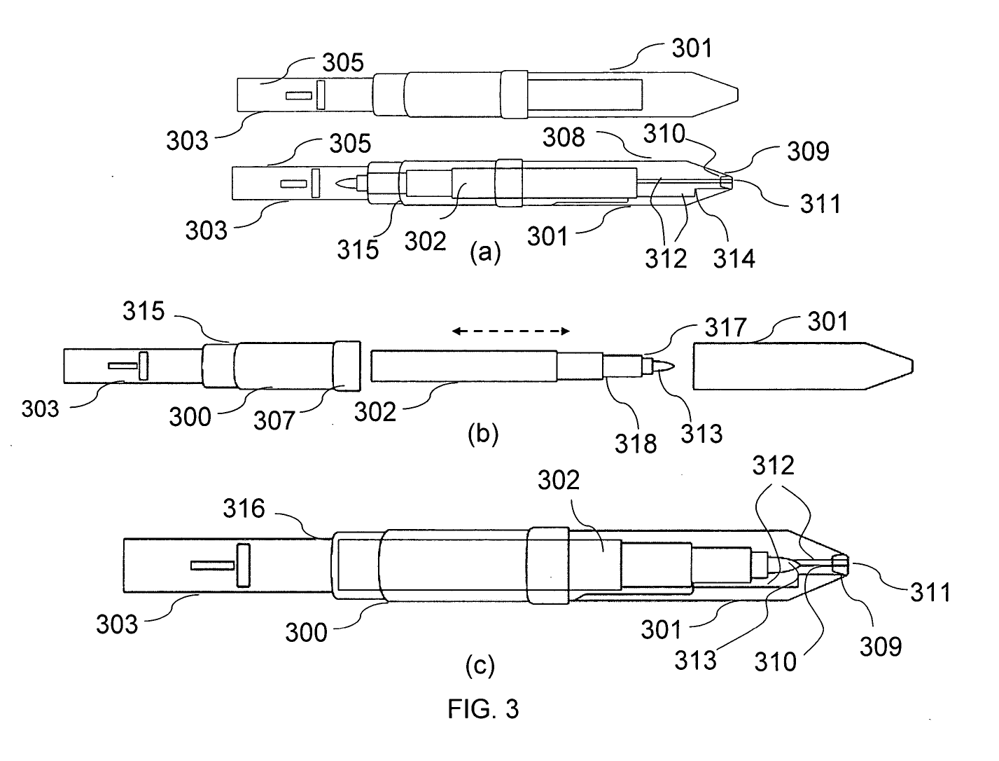

The body of the felt-tipped pen 202 has an absorbent nib 213. The absorbent nib 213 defines the required source of liquid to be dispensed and the pen can be positioned within the casing either with its nib 213 within the cap 205 of the mouthpiece 203 as shown in FIG. 2b, or with its nib positioned within or in close proximity to the orifice 310 of the nozzle 309 as shown in FIG. 3b and FIG. 3c. When in the former position, the nib 213 is intended to be effectively sealed within the cap 205 to prevent loss of fluid due to drying. When in the later position illustrated in FIG. 3c, the pen is supported centrally within the casing by the fins with a shoulder of the pen body abutting against projecting stops of the fins. In this position, the pen nib 313 extends into or is in close proximity to the orifice 310 of the nozzle 309.

During an embodiment of the invention, when the invention is in operational mode as illustrated in FIG. 1, FIG. 3b, and FIG. 3c air is blown by the user through the mouthpiece 303 and the annular passageways defined between the opposed surfaces of the pen body 302 and the internal surfaces of the casing 301. The fins 312 ensure that the pen is centralized within the casing 301. As the blown air approaches the outlet nozzle 309 it passes over the nib 313 and then leaves the casing through the orifice 310 and the expansion chamber 311. As the air enters and passes through the expansion chamber 311 it accelerates thereby inducing a swirling motion which ensures effective removal of liquid particles from the nib 313 of the pen 302. Sitting the nib correctly with respect to orifice 310 of the nozzle 309 enables even young children to produce high quality air brush effects when using the apparatus.

With this design, it is intended that when the apparatus is not in use as seen in FIG. 3a, the apparatus can be rearranged so that the pen 302 or cartridge is removed from its outer casing 301, as illustrated in FIG. 3b, inverted and re-inserted into the casing with the nib 313 of the pen or cartridge covered by the cap 305, as illustrated in FIG. 3a. The intention of so doing is to seal the nib 313 effectively within the cap 305 to prevent the nib from drying out.

The casing part 301 of this invention is shown in FIG. 3a. At its end remote from the nozzle 309, the casing can fit in a relatively tight manner into one end 307 of casing part 300. At its other end, casing part 301 has a nozzle 309 including an orifice 310 which opens into a converging expansion chamber 311. Three fins 312 protrude inwardly from the internal surfaces of the casing part 301. The fins include projecting stops at two positions. One set of projecting stops 314 are sited adjacent the orifice 310 of the casing; the other set of projecting stops 315 are sited downstream towards the casing end 308.

The pen can be positioned within the casing 300 either with its nib 313 within the cap 305 of the mouthpiece 303 as shown in FIG. 3a or with its nib positioned within or in close proximity to the orifice 310 of the nozzle 309 as shown in FIG. 3c. When in the former position, the rearward end 316 of the body of the felt-tipped pen 302 abuts against projecting stops 315 of the fins 312 so that the nib 313 projects far enough into the casing 300 to be effectively sealed within the cap 305 to prevent loss of fluid due to drying. The stops 315 prevent any movement of the pen relative to the casing, thereby ensuring that the pen nib is always effectively sealed by the cap. When in the latter position illustrated in FIG. 3a, the pen is supported centrally within the casing 300 by the fins 312 with a shoulder 317 of the pen body abutting against projecting stops 314 of the fins 312 and optionally with a shoulder 318 of the pen body abutting against projecting stops 315 of the fins 312. In this position, the pen nib 313 extends into or is in close proximity to the orifice 310 of the nozzle 309.

In an alternative un-illustrated embodiment, the casing is generally triangular in cross-section over a major part of its length with the three sides of the casing acting as locating surfaces to hold the pen in position. Thus, the need for fins is removed. In this embodiment, projecting stops may take the form of steps on the internal surface of the casing. The spaces between the apices of the internal surfaces of the casing and the pen body define the required passageways for the flow of air from the mouthpiece to the nozzle. In other respects, the casing may be the same as that shown in FIGS. 3a, 3b, and 3c.

Other casing shapes having more than three flat sides may be adopted. Thus, the casing may be square or diamond-shaped in cross-section. Also, the casing may be oval in cross-section.

The casing, nozzle and mouthpiece may be produced from plastics; other suitable materials may however be employed.

In a further un-illustrated embodiment, the casing includes an inner tube including projecting stops, within which the pen is positioned relatively tightly for at least part of the length of the inner tube. In this arrangement, the inner tube is positioned within and spaced from the internal surface of the casing to define an air flow passage which places the mouthpiece in communication with the casing nozzle. The inner tube is preferably substantially coaxial with the casing.

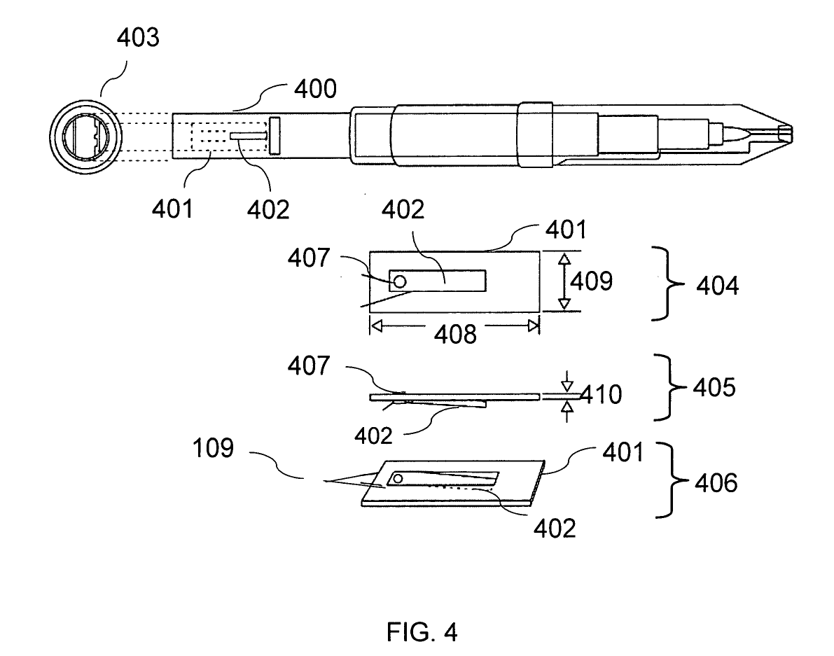

In yet another embodiment of the present invention illustrated in FIG. 4, the mouthpiece 400 comprises a sound-generating device 401 which creates a whistling sound as air passes through the mouthpiece 400 and out of an indented tab 402 in the sound-generating device 401. FIG. 4 illustrates a front view 403 of the mouthpiece 400 where the user blows air into the apparatus. In addition, FIG. 4 shows the top view 404, a side view 405, and a three dimensional top view 406 of the mouthpiece 400 showing the sound-generating device 401 and the indented tab 402, which is secured to the sound-generating device by a pin 407. The length of the indented tab 402 will alter the pitch of the sound generated by the particular liquid dispensing apparatus. In this way, a particular color of ink in the liquid dispensing apparatus can be associated with a particular pitch, which can be used as an associative learning tool for children.

In another embodiment, the aperture has a length 408, a width 409, and a thickness 410, and the sound generated by the mouthpiece 400 has a pitch that is dependent on the length 408 of the aperture 401. Therefore, the length 408 of the aperture 401 determines the pitch of the sound generated by the mouthpiece.

For all of the various embodiments described above, a finely dispersed spray of colored ink particles in air is achieved simply by blowing through the mouthpiece of the respective dispensing apparatus. The improved features of the dispensing apparatus in accordance with the invention enable the apparatus to be rearranged when not in use, and to remain stably rearranged regardless of external movement or vibration, so that the pen nib is always sufficiently covered to prevent drying or other damage occurring.

Although the present invention has been described in considerable detail with reference to certain embodiments thereof, other embodiments are possible. Therefore, the spirit and scope of the appended claims should not be limited to the description of the embodiments contained herein.

Furthermore, the present invention does not require that all the advantageous features need to be incorporated into every embodiment of the invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” in the claims herein is not intended to invoke the provisions of 35 U.S.C. Section 112, Paragraph 6.

What is claimed is:

1. A musical liquid dispensing apparatus for drawing while creating sounds, the musical liquid dispensing apparatus comprising:
a tubular casing having a first end and a second end, wherein the first end includes a nozzle having an orifice in communication with an expansion chamber bounded by sides which diverge away from the orifice, and wherein the second end includes a mouthpiece and an elongate cap, wherein the mouthpiece is configured to create a sound when a user blows air into the mouthpiece; and
a liquid source including an elongate body and an absorbent nib within the tubular casing with side surfaces of the elongate body spaced from internal wall surfaces of the tubular casing to define an air flow passageway therebetween, thereby allowing a user to dispense a fine spray of liquid particles to the orifice while creating a sound by blowing air through the mouthpiece and the passageway and passing a mixture of air and liquid over the nib and out though the orifice.

2. A musical liquid dispensing apparatus as set forth in claim 1, the musical liquid dispensing apparatus further comprising:
first stop means within the casing against which a surface of the elongate body can abut to position the nib of the liquid source within or in close proximity to the nozzle orifice; and
second stop means within the casing against which a rearward end of the elongate body can abut to position the nib of the liquid source in a relatively airtight manner into one end of the elongate cap, the other end of the elongate cap being closed, so that the liquid source can selectively be positioned with its nib within or in close proximity to the casing nozzle or with its nib effectively sealed within the elongate cap when the apparatus is not in use.

3. A musical liquid dispensing apparatus as set forth in claim 1, wherein the mouthpiece comprises an aperture and a means for creating sound through vibration movably attached to the aperture, whereby a user creates a sound by blowing air into the mouthpiece and passing varying levels of air through said aperture and through said means for creating sound, and whereby the means for creating sound vibrates generating sounds.

4. A musical liquid dispensing apparatus as set forth in claim 3, wherein the aperture has a length and a width, and a sound generated by the mouthpiece has a pitch, and wherein the length of the aperture determines the pitch of the sound generated by the mouthpiece.

5. A musical liquid dispensing apparatus as set forth in claim 2, wherein the first and second stop means may be the same.

6. A musical liquid dispensing apparatus as set forth in claim 2, wherein the locating means comprises a plurality of fins extending inwardly from inner surfaces of the casing.

7. A musical liquid dispensing apparatus as set forth in claim 6, wherein one or each stop means comprises steps formed in these fins.

8. A musical liquid dispensing apparatus as set forth in claim 1, wherein the casing is formed in two separable tubular parts, one such part terminating at one end in a socket into which one end of the other casing part can extend to define a relatively tight fit there-with.

9. A musical liquid dispensing apparatus as set forth in claim 2, wherein the liquid source is positioned with its nib within or in close proximity to the casing nozzle when in use.

10. A musical liquid dispensing apparatus as set forth in claim 2, wherein the first stop means within the casing is positioned to allow the liquid course to extend into or be in a close proximity to the orifice of the casing.

11. A musical liquid dispensing apparatus as set forth in claim 1, wherein the liquid source comprises a pen formed with a nib of absorbent material.

12. A musical liquid dispensing apparatus as set forth in claim 1, wherein the casing interior is formed over at least a major part of its length with three or more generally flat sides, the apices between neighboring sides defining passageways for the flow of air when a pen or cartridge is positioned in the casing.

13. A musical liquid dispensing apparatus as set forth in claim 1, wherein the casing interior is oval in cross-section.

14. A musical liquid dispensing apparatus as set forth in claim 1, wherein the locating means comprises an inner tube in which the liquid source locates, the airflow passageway being defined between the outer periphery of this tube and the internal periphery of an outer tube spaced from the inner tube and substantially coaxial therewith.

15. A method for forming a musical liquid dispensing apparatus, suitable for drawing and writing while creating sounds, the method comprising acts of:
forming a tubular casing having at one of its ends a nozzle having an orifice in communication with an expansion chamber bounded by sides which diverge away from the orifice, and at the other of its ends a mouthpiece and an elongate cap, wherein the mouthpiece is configured to create a sound when a user blows air into the mouthpiece; and
locating a liquid source including an elongate body and an absorbent nib within the tubular casing with side surfaces of the elongate body spaced from internal wall surfaces of the tubular casing to define an air flow passageway therebetween, whereby a user dispenses a fine spray of liquid particles to the orifice while creating a sound by blowing air through the mouthpiece and the passageway and passing a mixture of air and liquid over the nib and out though the orifice.

16. A method for forming a musical liquid dispensing apparatus as set forth in claim 15, the method further comprising acts of:
forming a first stop means within the casing against which a surface of the elongate body can abut to position the nib of the liquid source within or in close proximity to the nozzle orifice; and
forming a second stop means within the casing against which a rearward end of the elongate body can abut to position the nib of the liquid source in a relatively airtight manner into one end of the elongate cap, the other end of the elongate cap being closed, so that the liquid source can selectively be positioned with its nib within or in close proximity to the casing nozzle or with its nib effectively sealed within the elongate cap when the apparatus is not in use.

17. A method for forming a musical liquid dispensing apparatus as set forth in claim 15, wherein the mouthpiece comprises an aperture and a means for creating sound through vibration movably attached to the aperture, whereby a user creates a sound by blowing air into the mouthpiece and passing varying levels of air through said aperture and through said means for creating sound, and whereby the means for creating sound vibrates generating sounds.

18. A method for forming a musical liquid dispensing apparatus as set forth in claim 17, wherein the aperture has a length and a width, and a sound generated by the mouthpiece has a pitch, and wherein the length of the aperture determines the pitch of the sound generated by the mouthpiece.

19. A method for forming a musical liquid dispensing apparatus as set forth in claim 16, wherein in the acts of forming a one stop means and a two stop means, the first and second stop means may be the same.

20. A method for forming a musical liquid dispensing apparatus as set forth in claim 16, wherein the act of locating a liquid source comprises a plurality of fins extending inwardly from inner surfaces of the casing.

21. A method for forming a musical liquid dispensing apparatus as set forth in claim 20, wherein in the acts of forming a one stop means and a two stop means, one or each stop means comprises steps formed in these fins.

22. A method for forming a musical liquid dispensing apparatus as set forth in claim 15, wherein the casing is formed in two separable tubular parts, one such part terminating at one end in a socket into which one end of the other casing part can extend to define a relatively tight fit there-with.

23. A method for forming a musical liquid dispensing apparatus as set forth in claim 16, wherein the liquid source is positioned with its nib within or in close proximity to the casing nozzle when in use.

24. A method for forming a musical liquid dispensing apparatus as set forth in claim 16, wherein in the act of forming a first stop means, the first stop means within the casing is positioned to allow the liquid course to extend into or be in a close proximity to the orifice of the casing.

25. A method for forming a musical liquid dispensing apparatus as set forth in claim 15, wherein the liquid source comprises a pen formed with a nib of absorbent material.

26. A method for forming a musical liquid dispensing apparatus as set forth in claim 15, wherein the casing interior is formed over at least a major part of its length with three or more generally flat sides, the apices between neighboring sides defining passageways for the flow of air when a pen or cartridge is positioned in the casing.

27. A method for forming a musical liquid dispensing apparatus as set forth in claim 15, wherein the casing interior is oval in cross-section.

28. A method for forming a musical liquid dispensing apparatus as set forth in claim 15, wherein the act of locating a liquid source comprises an inner tube in which the liquid source locates, the airflow passageway being defined between the outer periphery of this tube and the internal periphery of an outer tube spaced from the inner tube and substantially coaxial therewith.
